(19) United States
(12) Patent Application Publication
(10) Pub. No.: US 2026/0354320 A1
(43) Pub. Date: Nov. 12, 2026

(54) VERTICAL FARMING SYSTEMS

(71) Applicant: Ariel Scientific Innovations Ltd., Ariel (IL)

(72) Inventors: Michael SASSOON, Ariel (IL); Gady GOLAN, Ariel (IL)

(73) Assignee: Ariel Scientific Innovations Ltd., Ariel (IL)

(21) Appl. No.: 19/515,507

(22) PCT Filed: Aug. 28, 2024
(86) PCT No.: PCT/IL2024/050863

§ 371 Date: Mar. 2, 2026

(30) Foreign Application Priority Data
Aug. 29, 2023 (IL) 305559

(51) Int. Cl. A01G 31/02; A01G 24/42; A01G 27/04; A01G 31/00

(52) U.S. Cl. CPC A01G 31/065; A01G 24/42; A01G 27/04; A01G 31/008

(57) ABSTRACT

A non-hydroponic vertical farming system for growing plants is disclosed. The system comprises a top portion and a bottom portion, each being configured for receiving and storing a fluid; at least one planting column; at least one planting port; a fluid return conduit being in fluid communication with the upper and lower portions of the planting column; a pump engaged with the fluid return; and a root cooling system for lowering a temperature of a solid planting material being contained within the planting ports.

### RELATED APPLICATION/S

This application claims the benefit of priority of Israeli Patent Application No. 305559, filed 29 Aug. 2023, the contents of which are incorporated herein by reference in their entirety.

### FIELD AND BACKGROUND OF THE INVENTION

The present invention, in some embodiments thereof, relates to a vertical farming system for growing plants and more particularly under suboptimal growth conditions.

Conventional field methods of farming are unsuited to desert regions since the demand for irrigation water is unsustainable and the soils are poor. Hothouse agriculture is costly to run due to the need for air conditioning. Another approach is hydroponics. However such systems are costly in capital investment and require refrigeration equipment to cool the nutrient solution which adds considerably to the operating costs. Such systems also generate very large quantities of waste water containing fertilizer which not only wastes a precious resource but also pollutes rivers and groundwater.

Conventional hydroponics use plants floating in a pool of nutrient solution. In order to cool the roots, the whole of the pool contents require cooling using electrically driven chillers. This is highly energy intensive since it requires that the thermal mass of the whole water system to be cooled. This invites undesirable heat transfer from the warm surroundings which is manifested in high electrical energy consumption. Another variation on hydroponics is aeroponics whereby the roots are misted or wetted by falling droplets from the top of vertical towers. The mist method requires highly filtered water which results in high maintenance and pumping costs. The tower method, in addition to chillers, requires many pumps. Both are vulnerable to power blackouts due to the rapid dryout of the roots if the flow is interrupted.

In non-hydroponics ground-based systems, there are attempts to cool the earth around the root bole using some form of heat exchanger. Typically this takes the form of water cooled plastic pipes buried in the soil or “cooling bayonets” inserted vertically near each plant.

However such methods are inefficient and costly. The inefficiency stems from the cooling system which requires that heat be transferred to the pipes from the root bole via the soil. The resistance to heat transfer is high due to the relatively small area of the pipes or bayonets, the low thermal conductivity of soil and the comparatively large distance through which the heat has to travel. This requires a large deltaT which in practice means that the chiller has to provide water at a temperature considerably below the optimum root temperature zone (RTZ). The colder the water provided by the chiller, the less efficient it is which results in higher running costs. In addition much of the cooling effect of the pipes is lost to the ground itself which acts as a (thermally) semi infinite body. Furthermore, the location of the pipes or bayonet heat exchangers is generally to one side of the plant. Not only is this asymmetric with respect to the root bole, but also causes further wastage of cooling energy to the soil rather than to the roots. Thus the method is not suitable for large scale agriculture due to the high capital cost (piping and chillers), high electricity demand (chillers and pumping losses) and high maintenance (leaks, damage to pipes caused by animals seeking moisture).

### SUMMARY OF THE INVENTION

According to an aspect of some embodiments of the present invention there is provided non-hydroponic vertical farming system for growing plants comprising:
a top portion and a bottom portion, each being configured for receiving and storing a fluid;
at least one planting column having an upper end and a lower end, the upper end being in fluid communication with the top portion and the lower end being in fluid communication with the bottom portion, the planting column being configured for transporting the fluid from the top portion to the bottom potion within the planting column, the planting column being hollow,
at least one planting port, having a proximal end and a distal end, the proximal end being connectable to, or integrally formed with, the planting column, at an oblique angle, forming fluid communication therebetween, the distal end facing the atmosphere;
a fluid return conduit being in fluid communication with the upper and lower portions;
a pump engaged with the fluid return conduit and being configured for moving the fluid from the bottom portion to the top portion, via the fluid return conduit; and
a root cooling system for lowering a temperature of a solid planting material being contained within the planting ports, thereby, when the vertical farming system being in service, lowering a temperature of roots of the plant to a desired temperature, while at the same time, not substantially effecting the temperature of foliage of the plant.

According to another aspect of some embodiments of the present invention there is provided non-hydroponic vertical farming system for growing plants comprising:
a top portion and a bottom portion, each being configured for receiving and storing a fluid;
at least one planting column having an upper end and a lower end, the upper end being in fluid communication with the top portion and the lower end being in fluid communication with the bottom portion, the planting column being configured for transporting the fluid from the top portion to the bottom potion within the planting column, the planting column being hollow,
at least one planting port, having a proximal end and a distal end, the proximal end being connectable to, or integrally formed with, the planting column, at an oblique angle, forming fluid communication therebetween, the distal end facing the atmosphere;
a fluid return conduit being in fluid communication with the upper and lower portions;
a pump engaged with the fluid return conduit and being configured for moving the fluid from the bottom portion to the top portion, via the fluid return conduit; and
a root cooling system for lowering a temperature of a solid planting material being contained within the planting ports, thereby, when the vertical farming system being in service, lowering a temperature of roots of the plant to a desired temperature.

According to embodiments of the invention, the upper end of the at least one planting column extends into an interior of the top portion.

According to embodiments of the invention, the upper end comprises at least one drainage hole.

According to embodiments of the invention, at least one side of the top portion is transparent.

According to embodiments of the invention, the at least one planting column comprises inner conduit for the transporting the fluid from the top portion to the bottom potion.

According to embodiments of the invention, the system further comprises at least one cartridge insertable into the at least one planting port and having a corresponding proximal end and a corresponding distal end, the cartridge comprising:
an outer capillary layer and the solid planting material contained therein or thereupon, the outer capillary layer for absorbing the fluid at the corresponding proximal end and forwarding the fluid via capillary motion in a direction of the corresponding distal end, while concomitantly the solid planting material forwarding the fluid to the roots of the plant.

According to embodiments of the invention, the solid planting material is covered with a layer fabricated from a non-absorbent material which reduces evaporation of moisture from cartridge.

According to embodiments of the invention, the at least one cartridge is biodegradable.

According to embodiments of the invention, a distal end of the cartridge is fabricated from a non-capillary material.

According to embodiments of the invention, the root cooling system is selected from the group consisting of a fan which forces ambient air into and/or above the fluid, a peltier cooler and a fluid chiller.

According to embodiments of the invention, the system further comprises a controller and at least one sensor for sensing moisture and/or temperature of the planting material, the controller being in communication with the root cooling system, the controller configured to control the temperature of the solid planting material, based on data obtained from the at least one sensor.

According to embodiments of the invention, the data relates to at least one of the following characteristics:
(i) temperature of the planting material;
(ii) moisture of the planting material;
(iii) pH of the planting material;
(iv) salinity of the planting material; and
(v) ambient temperature.

According to embodiments of the invention, the controller is in communication with the pump.

According to embodiments of the invention, the controller is connected to a server configured to receive, over a digital communication network, input data received from the at least one sensor.

According to embodiments of the invention, the system is a closed loop system.

According to embodiments of the invention, the solid planting material is porous.

According to embodiments of the invention, the solid planting material is devoid of soil.

According to embodiments of the invention, the solid planting material comprises a growth promoting agent.

According to embodiments of the invention, the solid planting material comprises organic material.

According to embodiments of the invention, the organic material comprises compost.

According to embodiments of the invention, the system is 1-3 m in height when erect.

According to embodiments of the invention, the top portion and the bottom portion are dismantable from the planting column.

According to embodiments of the invention, the system is powered locally.

According to embodiments of the invention, the local power is selected from the group consisting of a battery, solar power and wind power.

According to embodiments of the invention, the local power is solar power.

According to embodiments of the invention, the system further comprises a photovoltaic panel which is attachable to the top portion.

According to embodiments of the invention, the system is powered by a grid power supply.

According to another aspect of the invention, there is provided a method of growing at least one plant under suboptimal temperature conditions in a vertical culture system, the at least one plant having roots and foliage, the plant being planted in a solid planting material and not being grown hydroponically, the method comprising:
heating or cooling the solid planting material to a temperature different than a temperature to which the foliage being exposed when the plant is growing, thereby growing the at least one plant under suboptimal temperature conditions in the vertical culture system.

According to embodiments of the invention, the suboptimal temperature is a temperature below an optimal temperature and the method comprises heating the solid planting material.

According to embodiments of the invention, the suboptimal temperature is a temperature above an optimal temperature and the method comprises cooling the solid planting material.

According to embodiments of the invention, the plant is grown in the system described herein.

According to embodiments of the invention, the plant is an edible plant.

According to embodiments of the invention, the cooling is effected using a root cooling system selected from the group consisting of a fan which forces ambient air into or above the fluid used to water the plant, a peltier cooler and a fluid chiller.

According to another aspect of the invention, there is provided an article of manufacture comprising:
packaging comprising a plurality of plant growth cartridges,
each of the plurality of plant growth cartridges having a proximal end and a distal end,
wherein each cartridge comprises an external protective layer, an outer capillary layer and a solid planting material contained therein or thereupon, the outer capillary layer for absorbing fluid at the corresponding proximal end and forwarding the fluid via capillary motion in a direction of the distal end, while concomitantly the solid planting material being capable of forwarding the fluid to roots of a plant, when planted therein.

According to embodiments of the invention, the external protective layer is fabricated from a non-capillary material.

According to embodiments of the invention, the plant growth cartridges are pre-seeded.

According to embodiments of the invention, the plant growth cartridges comprise no more than 1 seed per cartridge.

According to embodiments of the invention, the article of manufacture further comprises a moisture absorber.

According to embodiments of the invention, the outer capillary layer is fabricated from a material that raises water to a height of at least 10 cm within 20 minutes.

According to embodiments of the invention, the material is selected from the group consisting of paper towel, cotton and polyvinyl acetate.

According to embodiments of the invention, the external protective layer is fabricated from a material that raises water to a height of less than 10 cm within 20 minutes.

According to embodiments of the invention, the solid planting material is a porous material.

According to embodiments of the invention, the solid planting material comprises a plant growth promoting agent.

According to embodiments of the invention, the seeds of the pre-seeded growth cartridges are seeds of edible plants.

According to embodiments of the invention, the article of manufacture is between 3-10 cm in height.

According to embodiments of the invention, the packaging comprises moisture-resistant packaging.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, such as assessing a subject, might be expected to use completely different methods, e.g., making use of expert knowledge and/or the pattern recognition capabilities of the human brain, which would be vastly more efficient than manually going through the steps of the methods described herein.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a vertical farming system according to embodiments of the invention.

FIG. 2 is a block diagram of a control unit which can be used to control a vertical farming system, according to embodiments of the invention.

FIG. 3 is a diagram illustrating an exemplary vertical farming system according to embodiments of the invention.

FIG. 4 is a diagram illustrating a solar powered vertical farming system according to embodiments of the invention.

FIG. 5 is a diagram illustrating a system comprising a cartridge, according to embodiments of the invention, and a plant which can be used with the vertical farming systems described herein.

FIG. 6 is a diagram of how a plant can be grown using a vertical farming system, according to embodiments of the invention.

FIG. 7 is a graph illustrating root cooling by evaporation from grow media (Relative humidity; 55%).

FIGS. 8A-B are photographs of an exemplary capillary layer 164 which is wound and inserted into outer protective layer 164. The capillary layer 164 includes a fine dot (FIG. 8A) or coarse dot (FIG. 8B) matrix of solid planting material 132.

### DESCRIPTION OF SPECIFIC EMBODIMENTS OF THE INVENTION

The present invention, in some embodiments thereof, relates to a vertical farming system for growing plants and more particularly under suboptimal growth conditions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

Current indications are that the world is heading for a food crisis. The world's population has passed the 8 billion mark whereas the availability of arable land is limited. Furthermore water for irrigation is becoming increasingly difficult to supply. Modern farming methods rely heavily on chemical fertilizers which are energy intensive to manufacture and, when disposed of, carry an environmental penalty.

Food supply is especially acute in developing countries which tend to have hot climates, low purchasing power and erratic power supplies. Refugee camps also have food needs for which the present method of trucking in food is problematic (world refugee population is approximately 85 M). Disaster zones also require a solution which enables low cost, rapid implementation. Growing food plants successfully demands a high level of knowledge, experience and technology which is often not available.

In order to supply future food needs there will be little choice but to develop large scale farming in the desert. However this carries its own set of problems, namely adequate supply of irrigation water, poor soil (most desert soils cannot be used directly for agriculture) and high ambient temperatures which makes it difficult for plants to survive. In addition, conventional (chemical based) fertilizer will be increasingly costly.

The present invention aims to counter these problems by using biodegradable cartridges containing solid growth media adapted to be used in a vertical farming system. The system provides root cooling and aeration, enabling growth under suboptimal conditions (e.g. in the desert) and has a low requirement for horticultural experience. Unlike hydroponic systems, the currently disclosed system consumes relatively small amounts of water and energy.

The principles and operation of the construction-modules according to the present invention may be better understood with reference to the drawings and accompanying descriptions.

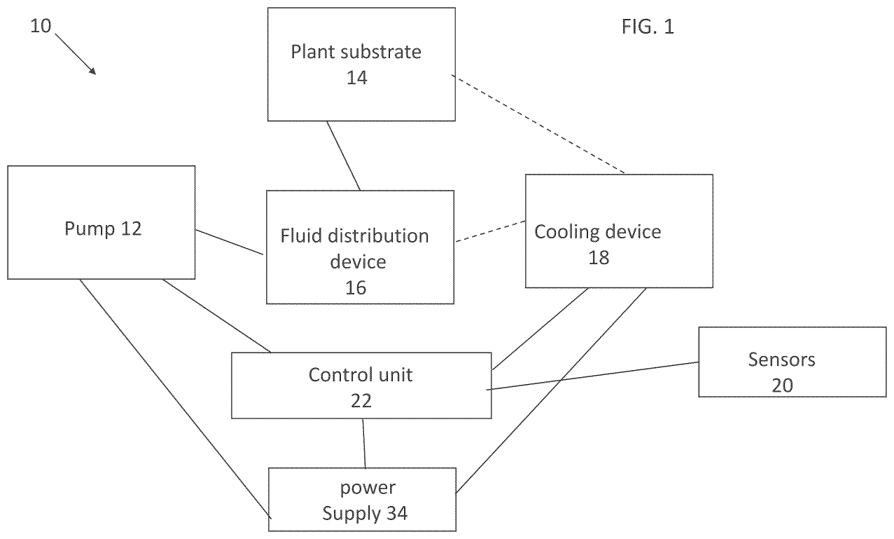

Reference is now made to FIG. 1, depicting a farming system for growing plants non-hydroponically, in which the roots of the plant are cooled.

Systems described herein are for growing plants non-terrestrially, such that at least two plants are grown using the system, where the first plant is positioned during growth period above the second plant (i.e. in a vertical orientation). The systems described herein are particularly useful for farming in a desert environment and/or in geographical locations having a hot, dry summer. In other embodiments, the systems may be used in roof-top gardening (commercial and hobbyist) and educational systems for schools/universities.

The term “non-hydroponic” refers to a farming system in which the plant is planted in a solid material which provides nutrients to the plant (i.e. non-inert). In non-hydroponic systems, such as the ones described herein, neither the solid material, nor the roots of the plant, are flooded with fluid.

According to some exemplary embodiments, a system for growing plants, for example system 10, comprises a plant substrate 14 in which plants are planted and a fluid distribution device 16 which comprises an arrangement of pipes or tubes through which fluid flows and waters the plants. In some embodiments the fluid distribution device is organized in a vertical arrangement (e.g. a tower) and the plants are grown in growth ports that extend diagonally from the tower. In some embodiments, the fluid flows intermittently through the pipes/tubes during the time the plants are grown. In other embodiments, the fluid flows continually through the pipes during the growth period of the plant.

The plant substrate 14 may be a solid planting material such as a porous substrate and/or a solid fibrous substrate. Examples of solid plant substrates include paper pulp, fly ash and conventional fiber-based growth materials such as coconut fiber, pearlite, vermiculite, or a manure based mix. The plant substrate may comprise inert granules such as perlite, vermiculite or sand. The plant substrate may comprise soil. In some embodiments, the plant substrate is devoid of soil.

Fluids which may be flowed through the system are aqueous based fluids. In one embodiment, the fluids comprise nutrients necessary for the health of the plant (e.g. Nitrogen, Phosphorous and Potassium (NPK) plus Trace elements). In one embodiment, the fluid has a lower nutrient content than the fluid used in hydroponic farming. In one embodiment, the amount of total nutrient (e.g. Nitrogen, Phosphorus or Potassium) in the fluid which is added to the system is less than 4 %, 3 %, 2 % or even 1 %.

In some embodiments, the system 10 further comprises a pump 12 (e.g. hydraulic pump) which allows fluid to be distributed through the fluid distribution device. In some embodiments, the fluid circulates throughout the system (e.g. in a closed loop) and may optionally be replaced intermittently. Preferably, the fluid that is added from outside the system 10 is devoid of fertilizer.

In some embodiments, system 10 further comprises a cooling device 18 which serves to cool the roots of the plant. Cooling device 12 may cool the fluid which is flowing in the fluid distribution device 16 or may act directly on the plant substrate 14. An examples of a cooling device includes a fan which forces ambient air into and/or over the fluid. This root device is based on latent cooling (i.e. not sensible cooling), also referred to herein as evaporative cooling or desert cooling. Latent cooling entails air entering the growth media (i.e. forced by the fan) and absorbing water vapor which has evaporated from the moist surfaces of the (porous) planting material and roots themselves. The evaporation process requires energy equivalent to the latent heat of evaporation of water which is approximately 0.66 kwh/kg. This energy comes mainly from the planting material/roots and, to some extent from the flowing air, resulting in a significant drop in temperature of the planting material/roots and the air. The degree of cooling can be controlled by the airflow generated by the fan speed.

The fluid in the fluid distribution device 16 can also be warmed to a desired temperature in response to thermostatic control by means of heating elements extending within the device. The heating elements may be heated by electrical means or by combustion of fuels.

It will be appreciated that the fluid used in the system may be stored in a holding vessel which is pre-cooled. For example, if the system is being used in the desert, the fluid in the holding vessel can be cooled sensibly by indirect contact with the relatively colder ambient night air temperature.

Thus, the fluid in the holding vessel may also be cooled by direct contact with the colder ambient night air by circulating the stored fluid through the whole system with the fan ON.

It will be appreciated that system 10 may comprise a fluid heating device, which may be used when the ambient temperature is low. For example, the heating device may be turned on at nights in the desert and the cooling device 12 may be used during the day. In some embodiments, system 10 comprises at least one sensor 20. Sensor 20 may sense at least one parameter of the surrounding air (e.g. temperature, humidity, wind speed etc.). Additionally, or alternatively sensor 20 may sense at least one parameter of solid plant substrate 14 (e.g. temperature, moisture level or salinity). Additionally, or alternatively sensor 20 may sense at least one parameter of the plant (e.g. number of leaves, height, or number of fruit).

Exemplary sensors that can be used to sense parameters of the air and/or plant substrate include thermometers (for temperature), pH meter (to measure pH of the plant substrate) hygrometer (to measure moisture content), camera (to analyze parameters of the plant).

Additional sensory that may be used to sense parameters of the fluid include temperature sensors and/or pH sensors.

System 10, may further comprise a control unit 22 which controls the pump 12 which pumps fluid through the fluid distribution device and optionally further controls the cooling device 18 (e.g. fan) such that the roots of the plant are kept at a predetermined temperature, or within a predetermined temperature range. Preferably, the temperature is at least 2 °C lower than ambient temperature, at least 3 °C lower than ambient temperature, at least 4 °C lower than ambient temperature, at least 5 °C lower than ambient temperature, at least 6 °C lower than ambient temperature, at least 7 °C lower than ambient temperature, at least 8 °C lower than ambient temperature, at least 9 °C lower than ambient temperature, at least 10 °C lower than ambient temperature.

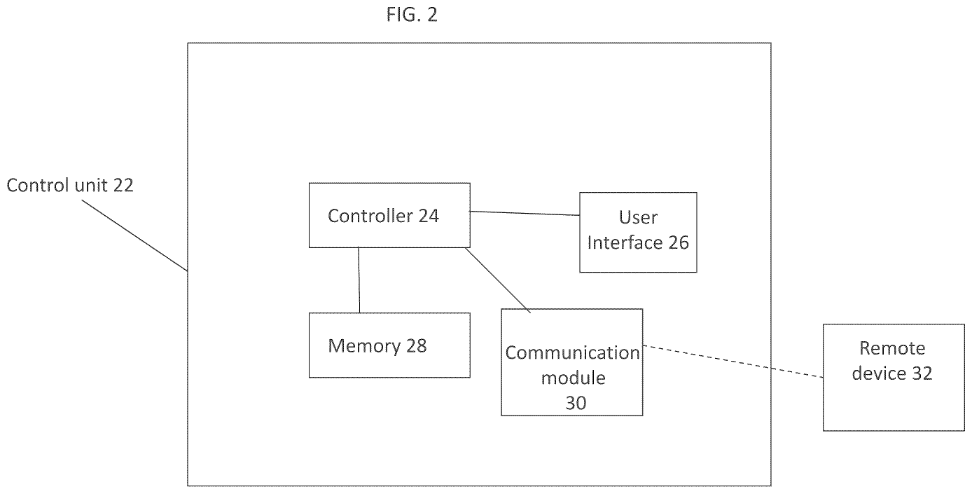

Components of an exemplary control unit 22 are presented in FIG. 2. According to one embodiment, control unit 22 comprises a controller 24 and a memory 28. The control unit 22 is configured to receive recordings recorded by the sensors 20 and control the pump 12 and/or cooling device 18 using at least one algorithm, formula or look-up table stored in the memory stored in the memory. The memory 28 contains data adapted to monitor the health/vitality of the plant and learn reactions to the change in pump parameters and cooling system parameters. In some embodiments, memory 28 includes a table reciting accumulated performance covering different plants species and a range of climatic conditions. The table may further include time of pump usage and/or cooling system usage duration of pump usage and/or cooling system usage and strength of cooling system. The table may be updated after a predefined number of hours or days. In some embodiments, memory 28 may comprise a machine learning algorithm.

For example: in some embodiments, an artificial intelligence (AI) driven computer system is provided. The AI system may be driven by machine learning processes such as neural nets; e.g. 14 deep learning algorithms, and/or evolutionary computation. Based on the collected data, the AI may adjust an irrigation regimen or recommend a particular irrigation regimen.

In some embodiments of the disclosure, the AI is provided in the form of circuitry, programming, and/or any combination of the two. In some embodiments, systems configured for AI-based learning yield results in the form of trained networks, selected weighting parameters, etc., which are provided in any suitable form for use with systems that may be non-learning systems. For example, an AI implementation in some embodiments collects inputs and “learns” associations for adjusting irrigation regimens based on particular inputs. The learned associations are converted into a form (for example, a software module and/or updated database; either being optionally for a network-connected portal site and/or for use on a user-operated device) which is made available to users, allowing users to take advantage of AI-produced results without necessarily requiring user-level direct access to AI-based learning systems.

In some embodiments, memory 28 provides inputs to controller 24 and affects determinations. Memory 28 may comprise a number of rules on pump usage and/or cooling system usage from which it can choose to output to controller 24.

In some embodiments, controller 44 is adapted to control the pump 12 and/or cooling device 18 in accordance with a limited number of predefined operation options. Optionally the operation options are manually adjustable by the user. For example, the memory may include a plurality of different options for time of pump usage and a plurality of options for selecting parameters of the root cooling device which are chosen by the user.

Controller 24 may be further connected to a communication module 30 (e.g. a wireless transmitter) for transmitting data relevant to the plants in the device to a remote device 32.

The remote device 32 may be located at a distance larger than 1 meter from the system 10, a remote device located outside at least one km from where the system 10 is located, a remote server, a cloud storage device, a remote database. In some embodiments, the at least one communication module 30 is configured to transmit and/or receive wireless signals from the remote device 32, for example Bluetooth signals, Wi-Fi signals, and/or cellular signals.

According to some exemplary embodiments, the controller 24 is configured to process and/or to generate the information flow indication, for example in a form of the BDindex, using one or more algorithms stored in the remote device. In some embodiments, the controller transmits the signals received from the sensors 20 to the remote device 32, and received processed signals or the information flow indication from the remote device 32. Optionally the processing and/or the generation of the information flow indication is performed in the remote device 32 using one or more algorithms stored in the remote device 32.

The data may be processed via the remote device 32 and transmitted to a user. The remote device 32 may generate reports that are customized according to location, type of crops and time of the year. Real time data may be sent to a phone/tablet/PC of the user, via user interface 26 which allows the user to have better information for optimal growth of plants, and to implement and/or adjust input strategies at any time.

In one embodiment, the controller 24 signals the user interface 26 to generate and deliver a human detectable readout of at least one sensor. In one embodiment, the user interface comprises a display, and wherein the controller signals the user interface to display the readout of the temperature sensed by the sensor on the display. The display may further show the number of times the pump has circulated the fluid over a particular time period. In another embodiment, the controller signals the user interface to generate and deliver an alarm signal if the pump is jammed and/or the cooling device is out of service.

A timer may optionally also provided in the control unit 22 for setting the operation of the device. Alternatively, an on/off switch is provided.

System 10 may further include a power source 34 adapted to provide power at least one component of system 10 (e.g. pump 12 and/or cooling system 18). Power source 34 is optionally a battery which may be recharged. Optionally, power source 34 is purely mechanical, such as a wind-up device where a mainspring is tightened for activation. Optionally, power source 34 comprises a photovoltaic panel and provides solar power. Other power sources known in the art may be used in accordance with exemplary embodiments of the invention.

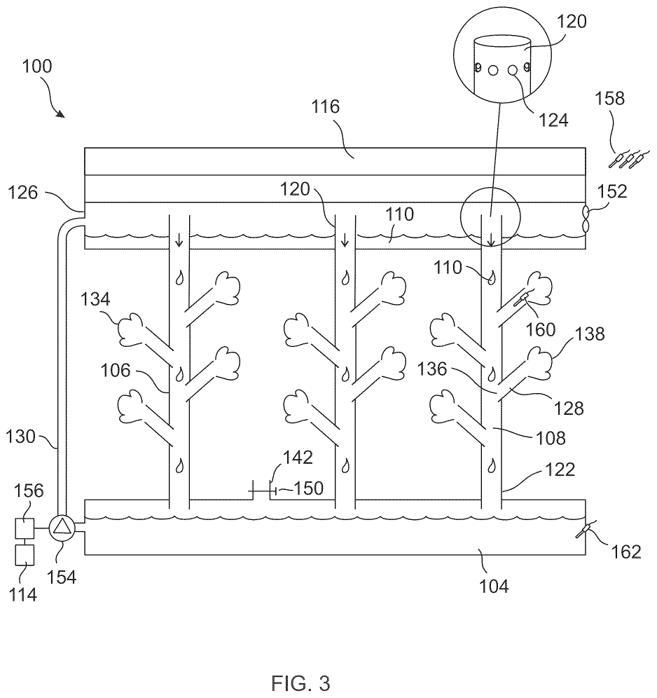

Referring to FIG. 3, an illustrative embodiment of a non-hydroponic, vertical farming system, referred to generally as 100, is shown.

The vertical farming system 100 comprises a top portion 102, a bottom portion 104, (each being configured for receiving and storing a fluid 110), and a planting column 106. The system 100 shown in FIG. 2 provides three planting columns 106, although it will be appreciated that any number of planting columns are contemplated (e.g. 2, 3, 4, 5, 6, 7, 8, 9, 10 or more), depending on the number of plants to be grown using the system. Thus, vertical farming system 100 is a modular system and the system can be adapted according to the number of plants being grown. The planting column 106 has a hollow interior 108, configured for transporting fluid 110 from the top portion 102 to the bottom potion 104 within the planting column 106. Planting column 106 has an upper end 120 which is in fluid communication with the top portion 102 and a lower end 122 which is in fluid communication with bottom portion 104. In one embodiment, upper end 120 of planting column 106 extends, (i.e. projects) into the interior of top portion 102. Preferably, the upper end 120 of each of the planting columns 106 of the system 100 project into top portion 102 by substantially equal amounts in order to ensure uniform drainage of fluid 110 into each of the planting columns 106. Optionally, planting column 106 comprises lighting system, for example LED strip lights.

Upper end 120 of the planting column 106 may optionally comprise a plurality of drainage holes 124 (e.g. forming a ring). The drainage holes 124 are sized to offer greater hydraulic resistance than the planting column 106 intakes which allows a head of fluid to build up for all the planting columns 106 before the fluid drains through the holes 124. If for any reason the holes 124 become blocked by algae or debris the flow can continue through the hollow planting columns 106. The drainage holes 124 may serve to allow fluid to drain if pump 154 becomes blocked (e.g. by algae or debris) or if it is not able to receive it's rated power (e.g. low battery) and the top portion 102 does not fill to the top and does not reach the lip of the planting column 106.

In use, bottom portion 104 sits on the ground or on a support placed on the ground. The bottom portion may be anchored by a bracket to the ground (e.g. an omega shaped bracket). The top portion 102 may be stabilized and attached to the ground using supports (e.g. ropes, guy lines or cables).

Top portion 102, bottom portion 104 and planting column 106 may be fabricated from a UV resistant material-e.g. a plastic such as polypropylene or HDPE. Planting column 106 may be connected to top portion 102 and bottom portion 106 using methods known in the art including a push-fit mechanism or by simple welding.

Planting column 106 may be between 1-5 meters (e.g. between 1-3 meters). Circumference of planting column 106 may be between 3-20 cm, 5-10 cm or 5-8 cm.

At least one end 126 of the top portion 102 may optionally be fabricated from a transparent material and may comprise markings to so as to facilitate adjustment to a horizontal position and observe fluid level. This is important to ensure there is an equivalent flow through each of the planting columns 106.

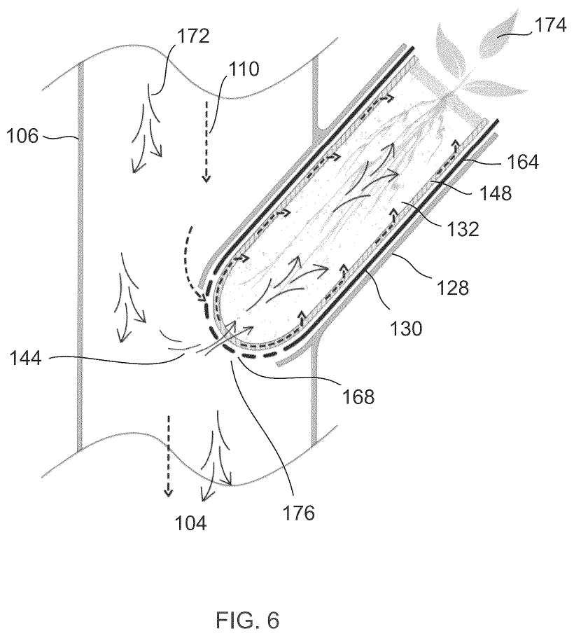

Positioned along the length of the planting column 106, on its outer perimeter are a plurality of planting ports 128. The planting ports 128 are sized and shaped to receive and house a cartridge 130 comprising a solid growth medium 132 in which a seed 112 or plant 134 is planted. The cartridge 130 is placed in the interior of the planting ports 128. The planting ports 124 are in fluid communication with the planting column 106 and typically protrude into the interior of the planting column 106. The planting ports 128 may have any cross-sectional shape —e.g. round, square, oval etc. Proximal end 136 of planting ports 128 protrude into the planting column 106 and connect at an angle, e.g. at an oblique angle. Distal end 138 of planting ports 128 face the atmosphere. Proximal end 136 may comprise openings 168 (e.g. perforations or slots) which allow liquid flowing down the planting column 106 to enter. Opening 168 of planting port is illustrated in FIG. 6.

Vertical farming system 100 further comprises a fluid return conduit 140 being in fluid communication with top portion 102 and bottom portion 104. Fluid return conduit 140 is configured to provide a mechanism for the fluid 110 within the bottom portion 104 to return to the top portion 102. Fluid return conduit 140 may be a hollow tube, pipe, or fluid passageway, and is connected the side wall of the bottom portion 104 via a pump 154.

Pump 154 may be controlled by a controller 156. Controller 156 can be used to ensure that the fluid 110 in the bottom portion 104 is pumped up to the top portion 102 via pump 154 at set time intervals. Controller 156 can further be used to control the strength of the pumping action. Controller 156 may be comprised in a control unit (for example control unit 22, as shown in FIG. 2). In this case, controller 156 is equivalent to controller 24.

For at least 70%, 80%, 90% of time during use (whilst plants are being grown), fluid 110 is not flowing down the planting column 106. In this way, the roots of the plant (and the solid growth medium 132) are not submersed in fluid. This is in sharp contrast to hydroponic systems, in which fluid the roots of a plant are fully submersed in fluid. Intermittently, fluid from the bottom portion 104 is pumped up to the top portion 102, whereby upon filling above the height of drainage holes 124 or upper end 120 of planting column, enters the planting column 106 and immediately begins to trickle down. The dimensions of the planting column 106 together with the dimensions of the upper portion 102 dictate the rate of flow of the fluid. Thus, fluid is not stored in the planting column per se and the planting ports 128 are not flooded. A typical rate of flow of fluid in the system is 2-5 LPM. It will be appreciated that the planting column 106 may further comprise an inner conduit which further limits the flow of the fluid. The inner conduit is typically configured such that it is in fluid communication with top portion 12, bottom portion 14 and with the planting ports 28. Additionally, or alternatively, planting column 106 may contain loose packing to create a larger contact area between water and air. (This may be particularly beneficial for oxygenating the water and sensible cooling of the water with nighttime desert air).

Fluid 110 may fill vertical farming system 100 via an inlet port 142 located on top portion 102 and/or bottom portion 104. Inlet port 142 may further comprise a valve 150 to control the amount of fluid entering the system.

Vertical farming system 100 further comprises a root cooling system (e.g. root cooling system 18) for lowering a temperature of a solid planting material 132 being contained within the planting ports, thereby, when the vertical farming system being in service, lowering a temperature of roots of the plant to a desired temperature. Optionally, the root cooling system lowers the temperature of the roots of the plant by at least 2 °C more than it lowers the foliage of the plant. Optionally, the root cooling system does not substantially affect the temperature of foliage of the plant.

In one embodiment, the root cooling system is a fan 152. The fan 152 may be connected to any part of system 100, such as for example top portion 102 (as illustrated in FIG. 3) or bottom portion 104. When energized, the fan 152 blows air into the system 100, for example top portion 102. The air moves in the system until it reaches the planting ports 128. From there, the air exits the system 100 and enters the cartridges 130, percolating through the solid growth media 132 on its way before exiting to the atmosphere. The system is configured such that the only exit point of the air is through the planting ports 128. This process supplies gaseous oxygen to the roots of the plant 134 in addition to the oxygen the roots obtain from the oxygen that is dissolved in the water. The air further cools the roots by evaporating moisture from the damp growth media 132 and the roots themselves. The root temperature is lowered by using the aeration air to evaporate moisture within the porous grow media. Of note, the above described configuration enables a thin layer of moisture on the roots, thus avoiding flooding or dryout.

In one embodiment, the fan 152 blows sufficient air, such that the temperature of the roots of the plant are lowered by at least 1 °C, 2 °C, 3 °C, 4 °C, 5 °C, 6 °C, 7 °C, 8 °C, 9 °C, 10 °C, less than ambient temperature. In another embodiment, the fan 50 blows sufficient air, such that the temperature of the roots of the plant are lowered by at least 1 °C 2 °C, 3 °C, 4 °C, 5 °C, 6 °C, 7 °C, 8 °C, 9 °C, 10 °C less than the temperature of the fluid 110 in the top portion 102, bottom portion 104 and planting column 106. In another embodiment, the fan 152 blows sufficient air, such that the temperature of the roots of the plant are lowered by at least 1 °C, 2 °C, 3 °C, 4 °C, 5 °C, 6 °C, 7 °C, 8 °C, 9 °C, 10 °C less than the temperature of the foliage of the plant.

Although not illustrated in FIG. 3, Fan 152 may optionally be under the command of controller 156. Controller 156 may control when the fan should work (i.e. at what time), the amount of time the fan is working and the strength of the fan in response to feedback received from sensors such as sensors 158, 160 and 162 in the system, wherein sensor 158 senses the ambient temperature and/or ambient humidity and sensor 160 senses the condition of the growth medium 132 (e.g. moisture level, acidity or the condition of the roots (e.g. root temperature), sensor 162 can measure the temperature of the fluid 110. Sensor 160 is typically placed by the root of the plant 134 inside cartridge 130. Controller 156 may further control the irrigation regime via controlling the frequency and duration of pump 154.

Controller 156 is configured for receiving data from one or more sensors 158, 160 and/or 162 indicative of one or more of temperature, moisture level are used as feedback to control the root cooling system and/or the pump.

Additionally or alternatively to a controller, system 100 may comprise a manual control (for example an actuator such as a slider) configured for enabling the pump and/or the root cooling system.

In certain cases controller 156 may control the root temperature such that it is maintained at a given profile throughout the day and night.

System 100 may further include a power source 114 adapted to provide power to at least one component of system 100. Power source 114 is optionally a battery which may be recharged. Optionally, power source 114 is purely mechanical, such as a wind-up device where a mainspring is tightened for activation.

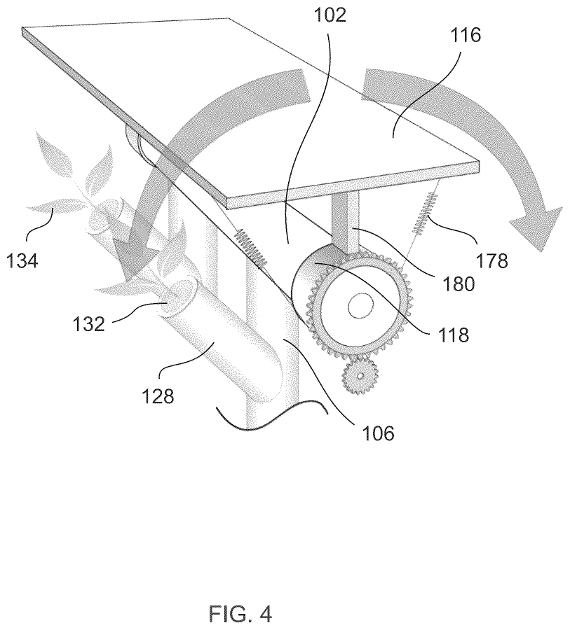

System 100 may be provided with at least one photovoltaic panel (e.g. solar panel) 116 for powering the pump 154 and/or cooling system (e.g. fan 152 and/or the sensors 158 and 160), as illustrated in FIG. 4. The solar panel 116 may be movable between a stowed position and a deployed position in which the solar panels are flared out in a fan-like pattern. The solar panels 116 may be attached to the top portion 102 of system 100 so as to provide shade to the plants 134 being grown underneath. Optionally, the solar panel 116 may be attached to the top portion 102 via at least one rotatable element 118, which allows the panel 116 to pivot according to the direction of the sun. Thus the panel 116 may track the sun in the azimuthal plane. The arc through which the panel moves is typically 90°. The solar panel 116 may be actuated by any suitable means (e.g. toothed rubber belt, steel cable or gear drive coupled to a stepper motor) and may be controlled remotely. Additional connecting elements 178 (side connecting element comprising a spring) and 180 (central rigid connecting element) may further aid in attaching the solar panel 116 to the top portion 102. In one embodiment, additional connecting elements comprise a spring. The solar panels 116 may be configured to power a specific module or multiple modules of the system. One or more solar panels 68 may be operatively connected to a battery source 114 connected to the system, and configured to allow charging of the battery source 114, as needed. Thus, the remote field controller and sensor may be a net-zero energy device.

It will be appreciated that the vertical farming systems described herein may be provided as a pre-constructed system or individual elements of the system may be provided separately (e.g. top portion 102, bottom portion 104 and planting column 106) and constructed on site. In one embodiment, the individual elements are packaged in a single packaging and transported to the site of construction (i.e. flat-pack). The packaging may further comprise a pump and/or a fan. In other embodiments, the packaging may further comprise a control unit, such as control unit 22. Planting column 106 may be provided such that it already comprises a plurality of planting ports 128. Alternatively, planting ports 128 may be provided as individual elements and connected to planting column 106 on site.

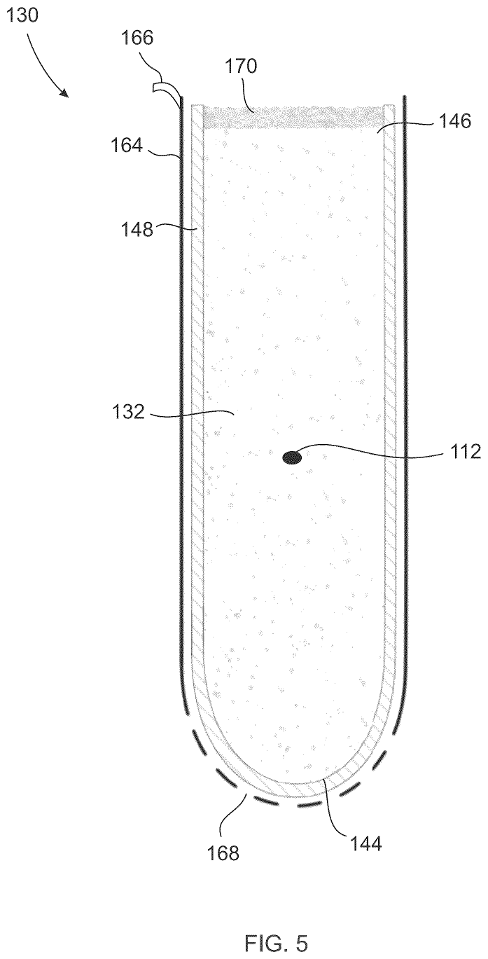

FIG. 5 illustrates an exemplary cartridge 130 which can be used with the vertical farming systems described herein.

Cartridge 130 has a proximal end 144 and a distal end 146. Cartridge 130 comprises an outer capillary layer 148 and a solid planting material 132 contained therein. Outer capillary layer 148 ensures correct moisture of solid planting material 132 by virtue of capillary action.

Proximal end 144 may be fortified with an additional layer (e.g. a metal mesh) to prevent the cartridge (or plant debris) from falling into the planting ports 128. The additional layer may form a neck to facility push-in assembly.

Cartridge 130 may comprise an outer protective layer 164. Outer protective layer 164 at its distal end, may comprise a tab 166, to aid in removal of cartridge 130 after use. Outer protective layer 164 may be colored to aid robot planting/harvesting). Outer protective layer 164 may be fabricated from water absorbent material or a water resistant material. Typically, outer protective layer 164 is fabricated from a material (e.g. paper) which has at least two fold or even 5 fold higher tensile strength than the outer capillary layer 148. Typically, outer protective layer 164 is fabricated from a material (e.g. paper) which is at least 2 fold or even 5 fold less water absorbent that the outer capillary layer 148. Typically, outer protective layer 164 is fabricated from a material (e.g. paper) having at least 2 fold or even 5 fold less capillarity that the outer capillary layer 148.

Thus, for example, the outer capillary layer 148 may be able to raise water through a height of 10 cm in no longer than 20 minutes and more preferably no longer than ten minutes. The rate of wicking of the outer capillary layer 148 is determined by the cross-sectional thickness of the layer. The thicker the layer the more water will be wicked up to the top of the cartridge 130. The capillary layer 148 ensures that the plant is neither over-watered or dried out.

The outer protective layer 164 may be able to raise water through a height of 10 cm in longer than 60 minutes and more preferably longer than two hours. Typical materials which can be used for the outer capillary layer include paper toweling, cotton fabric, Poly Vinyl Acetate. Typical materials which can be used for the outer protective layer include kraft paper, waxed paper or starch based biodegradable plastic.

In one embodiment, proximal end of outer protective layer 164 comprises holes or perforations 168.

Outer capillary layer 148 may be impregnated with a plant growth promoting agent, as further described herein below.

Additionally or alternatively, outer capillary layer 148 may be impregnated with a pelleted solid planting material, as further described herein below.

Cartridge 130 may be pre-filled with solid planting material 132. In one embodiment, at least 50 % of the cartridge is filled with solid planting material 132. In another embodiment, at least 60 % of the cartridge is filled with solid planting material 132. In another embodiment, at least 70 % of the cartridge is filled with solid planting material 132. In another embodiment, at least 80 % of the cartridge is filled with solid planting material 132. In another embodiment, at least 90 % of the cartridge is filled with solid planting material 132.

The solid planting material is designed to serve as an anchor for the plant roots, absorb moisture by radial diffusion from the wet capillary layer, enable air to flow through for oxygenation and evaporative cooling, deliver nutrients Examples of solid planting materials include porous (e.g. granular) material (which may or may not have significant capillarity), including paper pulp, fly ash, conventional fibre-based growth materials such as coconut fibre, pearlite, vermiculite. The solid planting material may comprise compost and may also be mixed with inert granules such as perlite, vermiculite, sand, paper pulp, fly ash, wood ash etc.

In one embodiment, the solid planting material is pelletized manure and/or other carbonaceous materials such as paper pulp and biomass: The composting process may be triggered by moisture when the cartridge is inserted into the system. This feature enables “slow release” low cost “organically sourced” nitrogen.

According to one embodiment, the solid planting material 132 comprises inorganic (Nitrate) nitrogen.

In one embodiment, solid planting material 132 does not comprise soil.

In another embodiment, solid planting material 132 does comprise soil.

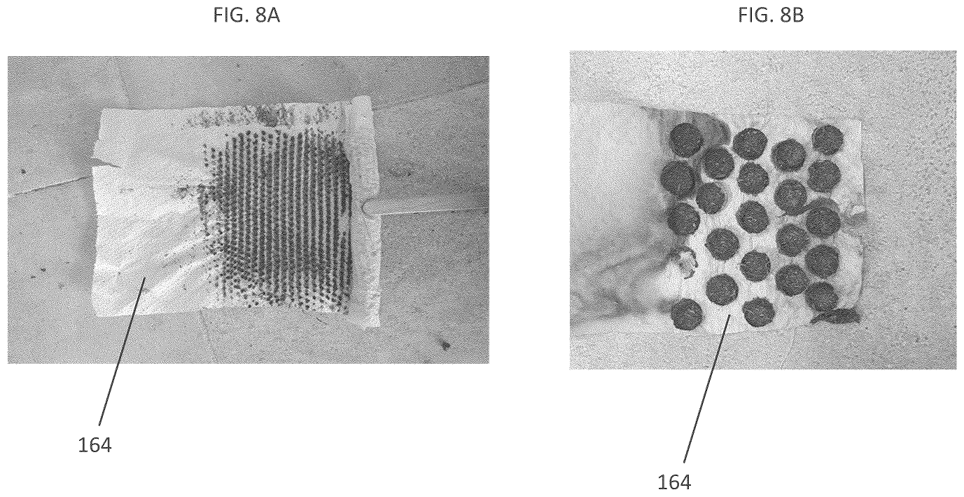

As mentioned above, the solid planting material 132 may be applied (e.g. printed, impregnated, coated, spotted) directly only the outer capillary layer 164—as depicted for example in FIGS. 8A-B. In the spotted version, a liquidized grow media may be applied using technique known in the art (e.g. inkjet printing). The “spots” can be printed in a pattern whereby the composition changes with depth of the grow tube. As is well known in the art, plants require different nutrient compositions for different phases in the growth cycle (e.g. the optimum nutrient composition is different for the vegetative phase and the flowering phase). Thus in the early seedling stage, the roots have not yet penetrated deeply and the “spots” may be composed of a mix favourable to vegetative growth. As the plant grow, the roots penetrate deeper down and come into contact with a different composition, more suited to that stage in the plants' life.

The capillary layer 164 may be spiral wound and inserted into the outer protective layer 164. Thus capillary layer 164 may comprise a plurality of layers. The solid planting material 132 may have a height which maintains a gap between layers of wound capillary layers, preventing the layers from sticking together when wet. This enables the roots of the plants to penetrate easily and provide unobstructed pathways for the passage of air. This embodiment, ensures good contact with moist paper for cooling and sufficient root aeration.

Above the solid planting material 132 may be a layer of a non-capillary, non-absorbent material 170 which serves as a plug preventing moisture from evaporating from the cartridge. Examples of material that can be used to generate the non-capillary plug include, for example coarse sand or fine gravel. The non-capillary material should be such that it does not prevent growth of the plant and allows the stem of the plant to penetrate therethrough.

Solid planting material 132 may comprise a plant growth promoting agent.

Examples of plant growth promoting agents include, but are not limited to fertilizer, an acaricide, a fungicide, an insecticide, a nematicide, a pesticide, a plant growth regulator and a nutrient.

The fertilizer can include, without limitation, ammonium sulfate, ammonium nitrate, ammonium sulfate nitrate, ammonium chloride, ammonium bisulfate, ammonium polysulfide, ammonium thiosulfate, aqueous ammonia, anhydrous ammonia, ammonium polyphosphate, aluminum sulfate, calcium nitrate, calcium ammonium nitrate, calcium sulfate, calcined magnesite, calcitic limestone, calcium oxide, calcium nitrate, dolomitic limestone, hydrated lime, calcium carbonate, diammonium phosphate, monoammonium phosphate, magnesium nitrate, magnesium sulfate, potassium nitrate, potassium chloride, potassium magnesium sulfate, potassium sulfate, sodium nitrates, magnesian limestone, magnesia, urea, urea-formaldehydes, urea ammonium nitrate, sulfur-coated urea, polymer-coated urea, isobutylidene diurea, K₂SO₄-2MgSO₄, kainite, sylvinite, kieserite, Epsom salts, elemental sulfur, marl, ground oyster shells, fish meal, oil cakes, fish manure, blood meal, rock phosphate, super phosphates, slag, bone meal, wood ash, manure, bat guano, peat moss, compost, green sand, cottonseed meal, feather meal, crab meal, fish emulsion, or a combination thereof.

The micronutrient fertilizer material can comprise boric acid, a borate, a boron frit, copper sulfate, a copper frit, a copper chelate, a sodium tetraborate decahydrate, an iron sulfate, an iron oxide, iron ammonium sulfate, an iron frit, an iron chelate, a manganese sulfate, a manganese oxide, a manganese chelate, a manganese chloride, a manganese frit, a sodium molybdate, molybdic acid, a zinc sulfate, a zinc oxide, a zinc carbonate, a zinc frit, zinc phosphate, a zinc chelate, or a combination thereof.

The insecticide can include an organophosphate, a carbamate, a pyrethroid, an acaricide, an alkyl phthalate, boric acid, a borate, a fluoride, sulfur, a haloaromatic substituted urea, a hydrocarbon ester, a biologically-based insecticide, or a combination thereof.

The herbicide can comprise a chlorophenoxy compound, a nitrophenolic compound, a nitrocresolic compound, a dipyridyl compound, an acetamide, an aliphatic acid, an anilide, a benzamide, a benzoic acid, a benzoic acid derivative, anisic acid, an anisic acid derivative, a benzonitrile, benzothiadiazinone dioxide, a thiocarbamate, a carbamate, a carbanilate, chloropyridinyl, a cyclohexenone derivative, a dinitroaminobenzene derivative, a fluorodinitrotoluidine compound, isoxazolidinone, nicotinic acid, isopropylamine, an isopropylamine derivative, oxadiazolinone, a phosphate, a phthalate, a picolinic acid compound, a triazine, a triazole, a uracil, a urea derivative, endothall, sodium chlorate, or a combination thereof.

The fungicide can comprise a substituted benzene, a thiocarbamate, an ethylene bis dithiocarbamate, a thiophthalidamide, a copper compound, an organomercury compound, an organotin compound, a cadmium compound, anilazine, benomyl, cyclohexamide, dodine, etridiazole, iprodione, metlaxyl, thiamimefon, triforine, or a combination thereof.

The fungal inoculant can comprise a fungal inoculant of the family Glomeraceae, a fungal inoculant of the family Claroidoglomeraceae, a fungal inoculant of the family Gigasporaceae, a fungal inoculant of the family Acaulosporaceae, a fungal inoculant of the family Sacculosporaceae, a fungal inoculant of the family Entrophosporaceae, a fungal inoculant of the family Pacidsporaceae, a fungal inoculant of the family Diversisporaceae, a fungal inoculant of the family Paraglomeraceae, a fungal inoculant of the family Archaeosporaceae, a fungal inoculant of the family Geosiphonaceae, a fungal inoculant of the family Ambisporaceae, a fungal inoculant of the family Scutellosporaceae, a fungal inoculant of the family Dentiscultataceae, a fungal inoculant of the family Racocetraceae, a fungal inoculant of the phylum Basidiomycota, a fungal inoculant of the phylum Ascomycota, a fungal inoculant of the phylum Zygomycota, or a combination thereof.

In one embodiment, the plant growth regulator is selected from the group consisting of: Abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpuridine, ethephon, flumetralin, flurprimidol, fluthiacet, forchlorfenuron, gibberellic acid, inabenfide, indole-3-acetic acid, maleic hydrazide, mefluidide, mepiquat (mepiquat chloride), naphthaleneacetic acid, N-6-benzyladenine, paclobutrazol, prohexadione (prohexadione-calcium), prohydrojasmon, thidiazuron, triapenthenol, tributyl phosphorotrithioate, 2,3,5-tri-iodobenzoic acid, trinexapac-ethyl and uniconazole. Other examples of plant growth regulators which can be comprised in the article of manufacture include those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie). Other plant growth regulators that can be incorporated seed coating compositions are described in US 2012/0108431, which is incorporated by reference in its entirety.

Preferred nematode-antagonistic biocontrol agents include ARF18; Arthrobotrys spp.; Chaetomium spp.; Cylindrocarpon spp.; Exophilia spp.; Fusarium spp.; Gliocladium spp.; Hirsutella spp.; Lecanicillium spp.; Monacrosporium spp.; Myrothecium spp.; Neocosmospora spp.; Paecilomyces spp.; Pochonia spp.; Stagonospora spp.; vesicular-arbuscular mycorrhizal fungi, Burkholderia spp.; Pasteuria spp., Brevibacillus spp.; Pseudomonas spp.; and Rhizobacteria. Particularly preferred nematode-antagonistic biocontrol agents include ARF18, Arthrobotrys oligospora, Arthrobotrys dactyloides, Chaetomium globosum, Cylindrocarpon heteronema, Exophilia jeanselmei, Exophilia pisciphila, Fusarium aspergilus, Fusarium solani, Gliocladium catenulatum, Gliocladium roseum, Gliocladium vixens, Hirsutella rhossiliensis, Hirsutella minnesotensis, Lecanicillium lecanii, Monacrosporium drechsleri, Monacrosporium gephyropagum, Myrotehcium verrucaria, Neocosmospora vasinfecta, Paecilomyces lilacinus, Pochonia chlamydosporia, Stagonospora heteroderae, Stagonospora phaseoli, vesicular-arbuscular mycorrhizal fungi, Burkholderia cepacia, Pasteuria penetrans, Pasteuria thornei, Pasteuria nishizawae, Pasteuria ramosa, Pastrueia usage, Brevibacillus laterosporus strain G4, Pseudomonas fluorescens and Rhizobacteria.

In another embodiment, the solid growth medium comprises a nutrient useful for plant growth. The nutrient can be selected from the group consisting of a nitrogen fertilizer including, but not limited to Urea, Ammonium nitrate, Ammonium sulfate, Non-pressure nitrogen solutions, Aqua ammonia, Anhydrous ammonia, Ammonium thiosulfate, Sulfur-coated urea, Urea-formaldehydes, IBDU, Polymer-coated urea, Calcium nitrate, Ureaform, and Methylene urea, phosphorous fertilizers such as Diammonium phosphate, Monoammonium phosphate, Ammonium polyphosphate, Concentrated superphosphate and Triple superphosphate, and potassium fertilizers such as Potassium chloride, Potassium sulfate, Potassium-magnesium sulfate, Potassium nitrate. Such compositions can exist as free salts or ions within the seed coat composition. Alternatively, nutrients/fertilizers can be complexed or chelated to provide sustained release over time.

Cartridge 130 may be pre-seeded with a seed 112. In one embodiment, the seed is of an agricultural plant.

The phrase “agricultural plants”, or “plants of agronomic importance”, refers to plants that are cultivated by humans for food, feed, fiber, and fuel purposes. In one embodiment, the plant is not a wild plant. According to a particular embodiment, the agricultural plant is edible.

In one embodiment, the seed of a monocotyledonous plant is used. Monocotyledonous plants belong to the orders of the Alismatales, Arales, Arecales, Bromeliales, Commelinales, Cyclanthales, Cyperales, Eriocaulales, Hydrocharitales, Juncales, Lilliales, Najadales, Orchidales, Pandanales, Poales, Restionales, Triuridales, Typhales, and Zingiberales. Plants belonging to the class of the Gymnospermae are Cycadales, Ginkgoales, Gnetales, and Pinales. In a particular embodiment, the monocotyledonous plant can be selected from the group consisting of a maize, rice, wheat, oats, barley and sugarcane.

In another embodiment, the seed of a dicotyledonous plant is used, including those belonging to the orders of the Aristochiales, Asterales, Batales, Campanulales, Capparales, Caryophyllales, Casuarinales, Celastrales, Cornales, Diapensales, Dilleniales, Dipsacales, Ebenales, Ericales, Eucomiales, Euphorbiales, Fabales, Fagales, Gentianales, Geraniales, Haloragales, Hamamelidales, Middles, Juglandales, Lamiales, Laurales, Lecythidales, Leitneriales, Magniolales, Malvales, Myricales, Myrtales, Nymphaeales, Papeverales, Piperales, Plantaginales, Plumb aginales, Podostemales, Polemoniales, Polygalales, Polygonales, Primulales, Proteales, Rafflesiales, Ranunculales, Rhamnales, Rosales, Rubiales, Salicales, Santales, Sapindales, Sarraceniaceae, Scrophulariales, Theales, Trochodendrales, Umbellales, Urticales, and Violates. In a particular embodiment, the dicotyledonous plant can be selected from the group consisting of cotton, soybean, pepper, and tomato.

Preferably, the seed of an agricultural plant is used. Agricultural plants include monocotyledonous species such as: maize (Zea mays), common wheat (Triticum aestivum), spelt (Triticum spelta), einkorn wheat (Triticum monococcum), emmer wheat (Triticum dicoccum), durum wheat (Triticum durum), Asian rice (Oryza sativa), African rice (Oryza glabaerreima), wild rice (Zizania aquatica, Zizania latifolia, Zizania palustris, Zizania texana), barley (Hordeum vulgare), Sorghum (Sorghum bicolor), Finger millet (Eleusine coracana), Proso millet (Panicum miliaceum), Pearl millet (Pennisetum glaucum), Foxtail millet (Setaria italica), Oat (Avena sativa), Triticale (Triticosecale), rye (Secale cereal), Russian wild rye (Psathyrostachys juncea), bamboo (Bambuseae), or sugarcane (e.g., Saccharum arundinaceum, Saccharum barberi, Saccharum bengalense, Saccharum edule, Saccharum munja, Saccharum officinarum, Saccharum procerum, Saccharum ravennae, Saccharum robustum, Saccharum sinense, or Saccharum spontaneum); as well as dicotyledonous species such as: soybean (Glycine max), canola and rapeseed cultivars (Brassica napus), cotton (genus Gossypium), alfalfa (Medicago sativa), cassava (genus Manihot), potato (Solanum tuberosum), tomato (Solanum lycopersicum), pea (Pisum sativum), chick pea (Cicer arietinum), lentil (Lens culinaris), flax (Linum usitatissimum) and many varieties of vegetables. In a particular embodiment, the agricultural plant is a cereal.

In another embodiment, the seed is of a vegetable.

It will be appreciated that the cartridge can be adapted according to the particular plant species grown within (for example the percent of N, P and K can be varied in solid medium and/or the thickness of capillary layer 148 may be varied according to the desired rate of capillary flow since different species of plant require different levels of moisture).

A plurality of cartridges 130 may be packaged in a single packaging-for example, packages of 5, packages of 10, packages of 20, packages of 50 or more. Each package may comprise an identical cartridge and labelled accordingly (e.g. adapted to a particular plant species). Alternatively, a single package may comprise a number of different cartridges each adapted towards a different plant species. The packaging may be a moisture resistant packaging. The packaging may further comprise a moisture absorber (e.g. silica, calcium sulfate, calcium fluoride, activated charcoal, molecular sieves, lithium chloride, calcium chloride and other such materials).

According to a particular embodiment, each cartridge 130 in the packaging comprises at least one seed, two, three of more seeds. The number of seeds in a cartridge will be dependent on the plant being grown. Thus, for example if the plant is a lettuce, the cartridge may comprise a single seed. If the plant being grown is water-cress, bean sprouts, the cartridge may be composed of a plurality of seeds (densely packed). In another embodiment, each cartridge in the packaging comprises no more than one seed. In still another embodiment, the cartridges are seedless. In this case, the non-capillary plug on top of the solid growth material is omitted. Optionally, the non-capillary plug can be supplied separately (e.g. in the same or different packaging).

FIG. 6 illustrates a system for the growth of a plant in cartridge 130 using a vertical farming system, such as vertical farming system 100. It will be appreciated that cartridge 130 may be used in different farming systems and it is not intended to be limiting to just system 100. In FIG. 6, cartridge 130 comprises an outer capillary layer 148 and a solid planting material 132 contained therein. Cartridge 130 may comprise an outer protective layer 164. In one embodiment, proximal end of outer protective layer 164 comprises holes or perforations 168. Cartridge 130 which comprises a seed (or optionally a small plant) is placed in the planting port 128 which is connected to planting column 106 of a vertical farming system. Placement in the planting port 128 (and removal from the planting port 128) can be carried out by hand or by robot. Fluid 110 flows down the planting column. The fluid 110 may be cooled using a cooling device. Air 172 may be blown into the fluid. Capillary layer 148 absorbs the fluid at its proximal end 144 and the fluid is wicked up the capillary layer as shown by the dotted line in capillary layer 148. The moisture then diffuses radially into the solid planting material 132 of the cartridge 130. In this way, the solid planting material 132 in each of the cartridges 130 receives an equal amount of moisture. This overcomes one of the most problematic issues in large scale aeroponics which is ensuring an even distribution of water to each plant. Fluid 110 which has not been absorbed by the cartridges 130 continues on its way down planting column 106 until it reaches the bottom portion 104 of the system. From there it may be pumped up to the upper portion (e.g. at periodic intervals determined by the controller), as described for system 100.

In one embodiment, cartridge 130 is biodegradable and after use can be safely discarded. It will be appreciated that since the fluid does not contain high levels of nutrients, discarding of unwanted fluid is also not a biohazard. The spent cartridges may also be used as raw material for solid fuel pellets as used in domestic boilers.

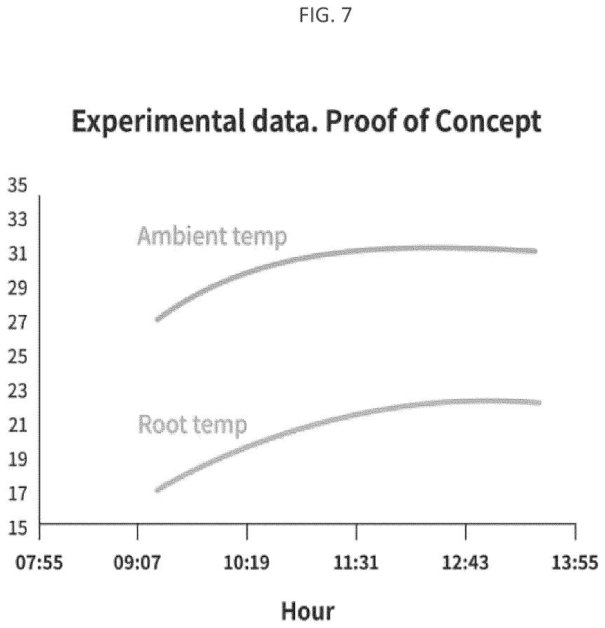

The present inventors have shown that using the system described herein, a plant could be grown whereby the root temperature of the plant was up to 9 °C lower than ambient temperature —see FIG. 7. A clear correlation between root zone temperature and airflow was seen.

Thus, according to another aspect of the present invention there is provided a method of growing at least one plant under suboptimal temperature conditions in a vertical culture system, the at least one plant having roots and foliage, the plant being planted in a solid planting material and not being grown hydroponically, the method comprising:
heating or cooling the solid planting material to a temperature different than a temperature to which the foliage being exposed when the plant is growing, thereby growing the at least one plant under suboptimal temperature conditions in the vertical culture system.

In one embodiment, the suboptimal temperature is a temperature above optimal temperature for growth of the plant and the method comprises cooling the solid material to a temperature which is lower than the temperature of the foliage. For example, this method of growing plants may be used in the desert, during the day, when ambient temperatures are above 35 °C or even above 40 °C. Examples of systems which may be used in order to cool the roots are described in FIGS. 1 and 3.

In another embodiment, the suboptimal temperature is a temperature below optimal temperature for growth of the plant and the method comprises heating the solid material to a temperature which is higher than the temperature of the foliage. For example, this method of growing plants may be used in the desert, during the night.

Typically, the plants which are grown using the methods described herein are edible plants, examples of which are provided herein above.

Systems described herein may have at least one of the following advantages over hydroponic growth of plants. Such advantages are described in further detail above.
Direct cooling of the roots by evaporation. The system enables much lower cooling costs than conventional electrically powered water chillers.
Provision of prepacked disposable cartridges of grow media that enable automated sowing and harvesting along with “plug and play” capability. Use of a wide range of cartridges to suit different plant types and methods of sowing (either pre-seeded or “drop in” seedlings).
The system does not require specialized knowledge (e.g. of horticulture) and thus can be applied to disaster zones, refugee camps and poorly educated communities.
Groundwater pollution caused by disposal of exhausted nutrient solution in conventional hydroponics is avoided by means of the cartridges which contain far less nutrient and therefore saves on fertilizer cost. The cartridges are biodegradable and when expended can be disposed of without causing environmental damage.
“Soiless” grow media based on paper pulp, sterilized compost from animal manure and power station ash. This avoids soil borne pathogens and utilizes low cost waste material.
Uniform and reliable irrigation by capillary action that accurately meters water directly to the roots and reduces evaporation loss by minimizing exposure of grow media resulting in very low water consumption. The system's very low water consumption and root cooling enables commercially viable large scale agriculture in desert regions.
Efficient aeration of the roots by forced convection of air through the porous grow media and circulation of highly oxygenated water. This gives an advantage over conventional field agriculture that relies on diffusion of oxygen through the soil (slow and erratic) or oxygenated water in hydroponics (requires considerable electrical energy consumption to obtain sufficient water circulation)
Provision of mineral fertilizer directly to the roots by impregnation of the capillary media. This results in greatly reduced fertilizer requirement.
“Low cost manufacture of supporting structure (use of mass produced plastic piping, integration of structural elements and plant system (irrigation etc.) into a single design and self-assembly). The system's structure enables compact shipping, rapid deployment and self-assembly in the field.

As used herein the term “about” refers to ±10 %.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

When reference is made to particular sequence listings, such reference is to be understood to also encompass sequences that substantially correspond to its complementary sequence as including minor sequence variations, resulting from, e.g., sequencing errors, cloning errors, or other alterations resulting in base substitution, base deletion or base addition, provided that the frequency of such variations is less than 1 in 50 nucleotides, alternatively, less than 1 in 100 nucleotides, alternatively, less than 1 in 200 nucleotides, alternatively, less than 1 in 500 nucleotides, alternatively, less than 1 in 1000 nucleotides, alternatively, less than 1 in 5,000 nucleotides, alternatively, less than 1 in 10,000 nucleotides.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A non-hydroponic vertical farming system for growing plants comprising:
a top portion and a bottom portion, each being configured for receiving and storing a fluid;
at least one planting column having an upper end and a lower end, said upper end being in fluid communication with said top portion and said lower end being in fluid communication with said bottom portion, said planting column being configured for transporting said fluid from said top portion to said bottom potion within said planting column, said planting column being hollow,
at least one planting port, having a proximal end and a distal end, said proximal end being connectable to, or integrally formed with, said planting column, at an oblique angle, forming fluid communication therebetween, said distal end facing the atmosphere;
a fluid return conduit being in fluid communication with said upper and lower portions;
a pump engaged with said fluid return conduit and being configured for moving said fluid from said bottom portion to said top portion, via said fluid return conduit; and
a root cooling system for lowering a temperature of a solid planting material being contained within said planting ports, thereby, when the vertical farming system being in service, lowering a temperature of roots of the plant to a desired temperature by evaporative cooling, while at the same time, not substantially effecting the temperature of foliage of the plant.

2. The system of claim 1, wherein said upper end of said at least one planting column extends into an interior of said top portion.

3-5. (canceled)

6. The system of claim 1, further comprising at least one cartridge insertable into said at least one planting port and having a corresponding proximal end and a corresponding distal end, said cartridge comprising:
an outer capillary layer and said solid planting material contained therein or thereupon, said outer capillary layer for absorbing said fluid at said corresponding proximal end and forwarding said fluid via capillary motion in a direction of said corresponding distal end, while concomitantly said solid planting material forwarding said fluid to said roots of the plant.

7-8. (canceled)

9. The system of claim 6, wherein a distal end of said cartridge is fabricated from a non-capillary material.

10. The system of claim 1, wherein said root cooling system is selected from the group consisting of a fan which forces ambient air into and/or above the fluid, a peltier cooler and a fluid chiller.

11. The system of claim 1, further comprises a controller and at least one sensor for sensing moisture and/or temperature of said planting material, said controller being in communication with said root cooling system, said controller configured to control the temperature of said solid planting material, based on data obtained from said at least one sensor.

12-14. (canceled)

15. The system of claim 1, being a closed loop system.

16. The system of claim 1, wherein said solid planting material is porous.

17. The system of claim 1, wherein said solid planting material is devoid of soil.

18. The system of claim 1, wherein said solid planting material comprises a growth promoting agent.

19-27. (canceled)

28. A method of growing at least one plant under suboptimal temperature conditions in a vertical culture system, the at least one plant having roots and foliage, the plant being planted in a solid planting material and not being grown hydroponically, the method comprising:
heating or cooling said solid planting material to a temperature different than a temperature to which said foliage being exposed when the plant is growing, thereby growing the at least one plant under suboptimal temperature conditions in the vertical culture system.

29. The method of claim 28, wherein said suboptimal temperature is a temperature below an optimal temperature and said method comprises heating said solid planting material.

30. The method of claim 28, wherein said suboptimal temperature is a temperature above an optimal temperature and said method comprises cooling said solid planting material.

31. The method of claim 30, wherein said plant is grown in the system of which comprises:
a top portion and a bottom portion, each being configured for receiving and storing a fluid;
at least one planting column having an upper end and a lower end, said upper end being in fluid communication with said top portion and said lower end being in fluid communication with said bottom portion, said planting column being configured for transporting said fluid from said top portion to said bottom potion within said planting column, said planting column being hollow,
at least one planting port, having a proximal end and a distal end, said proximal end being connectable to, or integrally formed with, said planting column, at an oblique angle, forming fluid communication therebetween, said distal end facing the atmosphere;
a fluid return conduit being in fluid communication with said upper and lower portions;
a pump engaged with said fluid return conduit and being configured for moving said fluid from said bottom portion to said top portion, via said fluid return conduit; and
a root cooling system for lowering a temperature of a solid planting material being contained within said planting ports, thereby, when the vertical farming system being in service, lowering a temperature of roots of the plant to a desired temperature by evaporative cooling, while at the same time, not substantially effecting the temperature of foliage of the plant.

32-33. (canceled)

34. An article of manufacture comprising:
packaging comprising a plurality of plant growth cartridges,
each of said plurality of plant growth cartridges having a proximal end and a distal end,
wherein each cartridge comprises an external protective layer, an outer capillary layer and a solid planting material contained therein or thereupon, said outer capillary layer for absorbing fluid at said corresponding proximal end and forwarding said fluid via capillary motion in a direction of said distal end, while concomitantly said solid planting material being capable of forwarding said fluid to roots of a plant, when planted therein.

35. (canceled)

36. The article of manufacture of claim 34, wherein said plant growth cartridges are pre-seeded.

37-41. (canceled)

42. The article of manufacture of claim 34, wherein said solid planting material is a porous material.

43. The article of manufacture of claim 34, wherein said solid planting material comprises a plant growth promoting agent.

44-46. (canceled)
